(19) United States
(12) Patent Application Publication
(10) Pub. No.: US 2013/0148256 A1
(43) Pub. Date: Jun. 13, 2013

(54) LAMINATED CERAMIC ELECTRONIC COMPONENT

(71) Applicant: Murata Manufacturing Co., Ltd., Nagaokakyo-shi (JP)

(72) Inventors: Shoichiro SUZUKI, Nagaokakyo-shi (JP); Masanori NAKAMURA, Nagaokakyo-shi (JP); Koichi BANNO, Nagaokakyo-shi (JP); Taisuke KANZAKI, Nagaokakyo-shi (JP); Akihiro SHIOTA, Nagaokakyo-shi (JP); Masahiro OTSUKA, Nagaokakyo-shi (JP)

(73) Assignee: MURATA MANUFACTURING CO., LTD., Nagaokakyo-shi (JP)

(21) Appl. No.: 13/759,085

(22) Filed: Feb. 5, 2013

Related U.S. Application Data
(63) Continuation of application No. PCT/JP2011/067395, filed on Jul. 29, 2011.

(30) Foreign Application Priority Data
Aug. 18, 2010 (JP) 2010-183057

(51) Int. Cl. H01G 4/12; H01G 4/008; H01G 4/30

(52) U.S. Cl. CPC H01G 4/1218; H01G 4/30; H01G 4/008
USPC 361/301.4

(57) ABSTRACT

A laminated ceramic electronic component includes a laminated body including a plurality of stacked ceramic layers and a plurality of internal electrodes arranged along interfaces between the ceramic layers, and an external electrode located on an outer surface of the laminated body. In the laminated ceramic electronic component, the ceramic layers have a composition including a main constituent of a barium titanate-based compound and Bi₂O₃, and the internal electrodes have a main constituent of Al.

### BACKGROUND OF THE INVENTION

1. Field of the Invention

The present invention relates to a laminated ceramic electronic component such as a laminated ceramic capacitor, for example.

2. Description of the Related Art

A laminated ceramic capacitor 1 as a typical example of laminated ceramic electronic components will be described first with reference to FIG. 1.

The laminated ceramic capacitor 1 includes a laminated body 2 configured with the use of a plurality of stacked dielectric ceramic layers 3 and a plurality of internal electrodes 4 and 5 formed along the specific interfaces between the dielectric ceramic layers 3.

First and second external electrodes 8 and 9 are formed in positions different from each other on the outer surface of the laminated body 2. In the laminated ceramic capacitor shown in FIG. 1, the first and second external electrodes 8 and 9 are formed respectively on respective end surfaces 6 and 7 of the laminated body 2, which are opposed to each other. The internal electrodes include a plurality of first internal electrodes 4 electrically connected to the first external electrode 8; and a plurality of second internal electrodes 5 electrically connected to the second external electrode 9, and the first and second internal electrodes 4 and 5 are arranged alternately with respect to the stacking direction. First plating layers 10, 11 and second plating layers 12, 13, if necessary, are formed on the surfaces of the external electrodes 8 and 9.

The reduction in size is required for laminated ceramic capacitors, and thus, in the production process, an approach is employed in which green sheets of a dielectric ceramic and internal electrode layers are stacked, and then subjected to firing concurrently. For cost reduction, base metals such as Ni are used for internal electrodes of laminated ceramic capacitors.

In recent years, with the further progress of reduction in layer thickness for dielectric ceramic layers, the reduction in layer thickness for internal electrodes has also been accelerated. However, the reduction in layer thickness for internal electrodes leads to a problem that spherically-shaped metal particles are likely to decrease the coverage of the internal electrodes, and the need for firing at lower temperatures is thus created.

In addition, because of the requirements of various characteristics for laminated ceramic electronic components, there has also been a need to use a variety of metals such as Ag and Cu as metals for internal electrodes. Also for this reason, the need for firing at lower temperatures has been created.

Thus, there is a need for a ceramic material which is able to be fired at low temperatures, and exhibits an excellent dielectric property.

For example, Japanese Patent Application Laid-Open No. 2007-290940 discloses a barium titanate-based dielectric ceramic composition which is suitable for multilayer substrates and laminated ceramic capacitors, and mentions that the composition is able to be fired at 1000° C. or lower.

In addition, Japanese Patent Application Laid-Open No. 2009-132606 discloses a barium titanate-based dielectric ceramic composition which is suitable for laminated ceramic substrates, and mentions that the composition is able to be fired at 1000° C. or lower.

However, laminated ceramic electronic components prepared with the use of the dielectric ceramic composition in Japanese Patent Application Laid-Open No. 2007-290940 have a problem that sufficient moisture resistance is not achieved while firing at low temperatures is possible.

In addition, likewise, laminated ceramic electronic components prepared with the use of the dielectric ceramic composition in Japanese Patent Application Laid-Open No. 2009-132606 also have a problem that sufficient moisture resistance is not achieved while firing at low temperatures is possible.

### SUMMARY OF THE INVENTION

Therefore, preferred embodiments of the present invention provide a laminated ceramic electronic component which is able to be adequately fired at low temperatures, and has sufficient moisture resistance.

More specifically, a preferred embodiment of the present invention provides a laminated ceramic electronic component including a laminated body including a plurality of stacked ceramic layers and a plurality of internal electrodes arranged along interfaces between the ceramic layers, and an external electrode located on an outer surface of the laminated body, wherein in the laminated ceramic electronic component, the ceramic layers have a composition including a main constituent of a barium titanate-based compound and Bi₂O₃, and the internal electrodes have a main constituent of Al.

In addition, in the laminated ceramic electronic component according to a preferred embodiment of the present invention, the content of the Bi₂O₃ with respect to 100 parts by weight of the main constituent in the ceramic layers is preferably about 1 part by weight or more and about 20 parts by weight or less, for example.

Furthermore, in the laminated ceramic electronic component according to a preferred embodiment of the present invention, the ceramic layers preferably further contain CuO at about 0.01 parts by weight or more and about 1 part by weight or less with respect to 100 parts by weight of the main constituent, for example.

According to various preferred embodiments of the present invention, a laminated ceramic electronic component can be provided which is able to be adequately fired at low temperatures, and has sufficient moisture resistance.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram schematically illustrating an example of a laminated ceramic capacitor as an example of a laminated ceramic electronic component according to a preferred embodiment of the present invention.

FIG. 2 is a photograph of an enlarged interface between an internal electrode and a ceramic layer, and the vicinity of the interface, in a laminated ceramic capacitor according to an example of a preferred embodiment of the present invention.

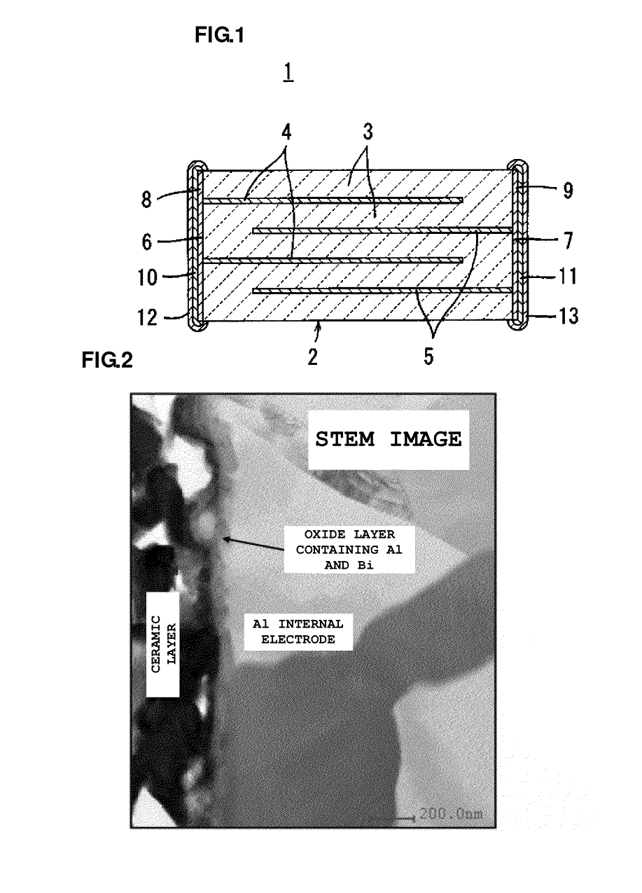

### DETAILED DESCRIPTION OF THE PREFERRED EMBODIMENTS

The laminated ceramic electronic component according to a preferred embodiment of the present invention includes the advantageous and distinctive features of a ceramic layer composition including a main constituent of a barium titanate-based compound and Bi₂O₃, and internal electrodes containing Al as their main constituent. This combination provides adequate moisture resistance, in spite of being capable of adequate firing at low temperatures. This is because an oxide layer containing Al and Bi is located at the interfaces between the ceramic layers and the internal electrodes to reinforce the interfaces so as to significantly reduce and prevent the ingress of moisture and the elution of the interface layer.

The internal electrodes are preferably Al alone, which may be an alloy with other metal without impairing the advantageous features of preferred embodiments of the present invention. Preferably, the Al content ratio is about 90% or more in terms of molar ratio, for example.

In the composition of the ceramic layers, the main constituent is a barium titanate-based compound, thus achieving higher electrostatic capacitance. The barium titanate-based compound is represented by the general formula: perovskite BaTiO₃, which may have some of Ba substituted with Ca and/or Sr, and may have some of Ti substituted with Zr and/or Hf. The respective substitution amounts are preferably about 20 mol % or less in total for Ca and Sr and about 10 mol % or less in total for Zr and Hf to ensure desired electrical characteristics.

In addition, the molar ratio between the Ba site and the Ti site in the main constituent basically has a numerical value close to 1, which can be controlled in the range of about 0.97 or more and about 1.05 or less, for example, without impairing the advantageous features of preferred embodiments of the present invention.

The content of Bi₂O₃ in a preferred embodiment of the present invention is preferably about 1 part by weight or more and about 20 parts by weight or less with respect to 100 parts by weight of the main constituent, for example. In this case, the electrostatic capacitance of the laminated ceramic electronic component is further increased. This is considered to be because the presence of Bi significantly reduces and prevents the oxidation of the Al internal electrode surfaces to a moderate level so as to significantly reduce and prevent the relative increase in the thickness of the ceramic layer section between adjacent internal electrodes.

In addition, in the laminated ceramic electronic component according to a preferred embodiment of the present invention, the ceramic layers further contain CuO at about 0.01 parts by weight or more and about 1 part by weight or less with respect to 100 parts by weight of the main constituent, for example, so as to further improve the electrostatic capacitance. This is considered to be because the coexistence of CuO with Bi₂O₃ further progresses the densification of the ceramic even in the case of low-temperature firing under similar conditions.

In addition, without impairing the advantageous features of preferred embodiments of the present invention, rare-earth elements, Mg, Mn, V, Al, Ni, Co, Zr, etc., may be included as accessory constituents in preferred embodiments of the present invention.

Next, a non-limiting example of a method for producing a ceramic raw material powder will be described for forming the ceramic layers.

First, powders of oxides or carbonates of Ba, Ti, etc. are prepared as starting raw materials for the main constituent. These starting raw material powders are weighed, and subjected to mixing and grinding in a liquid with the use of media. After drying, the mixed powder obtained is subjected to a heat treatment, thereby providing a BaTiO₃ powder as a main constituent. This method is generally called a solid-phase synthesis method, and wet synthesis methods such as a hydrothermal synthesis method, a hydrolysis method, and an oxalic acid method may be used as another method, for example.

Next, a predetermined amount of Bi₂O₃ powder and if necessary, CuO are added to this main constituent powder. The Bi source and the Cu source are not to be considered limited to any oxide powders without impairing the advantageous features of preferred embodiments of the present invention. Then, these powders are mixed in a liquid, and subjected to drying to obtain a ceramic raw material powder as a final raw material.

Next, a method for manufacturing the laminated ceramic electronic component according to a preferred embodiment of the present invention will be described with a laminated ceramic capacitor as a non-limiting example.

First, a ceramic raw material is prepared. This ceramic raw material is mixed with, if necessary, an organic binder constituent in a solvent to provide a ceramic slurry. This ceramic slurry is subjected to sheet forming, thereby providing ceramic green sheets.

Next, an internal electrode containing Al as its main constituent is formed on the ceramic green sheets. There are several methods for this formation, and a method is simple in which an Al paste containing an Al powder and an organic vehicle is applied in a desired pattern by screen printing. Other methods include a method of transferring Al metal foil and a method of forming an Al film while masking by a vacuum thin film formation method.

In this way, the ceramic green sheets and the Al internal electrode layers are stacked many times, and subjected to pressure bonding, thereby providing an unfired raw laminated body.

This raw laminated body is subjected to firing at a predetermined temperature in a predetermined atmosphere in a firing furnace. For example, with an oxygen partial pressure adjusted to 1×10⁻⁴ MPa or higher and a firing temperature adjusted to 600° C. or higher during the firing, the interfaces between the ceramic layers and the internal electrodes are reinforced stably. More preferably, the firing temperature set not to be lower than the melting point of Al, for example, 670° C. or higher reinforces the interfaces more stably.

In addition, for example, when the firing temperature is adjusted to 1000° C. or lower, the internal electrodes containing Al as their main constituent is prevented effectively from being spherically shaped. As for the oxygen partial pressure, the atmospheric pressure is most preferable in view of the simpleness of the step.

In addition, when the rate of temperature increase from room temperature to top temperature is adjusted to 100° C./minute or more in the firing step, the interfaces are more likely to be reinforced even when there are various changes in ceramic material composition, stacked structure design, etc. This is considered to be due to the fact that an oxide layer containing Al and Bi is formed at the interfaces between the ceramic layers and the internal electrodes before the Al flow is increased due to melted Al.

It is to be noted that although the melting point of Al is approximately 660° C., the manufacturing method according to a preferred embodiment of the present invention allows co-firing with the ceramic even at temperatures significantly higher than 660° C. This is considered to be due to the oxide layers formed at the surface layer sections of the Al internal electrodes. For this reason, the material composition design for the ceramic used also has a high degree of freedom produced, thereby making it possible to have various applications.

It is to be noted that the laminated ceramic electronic component according to preferred embodiments of the present invention is able to be applied to not only laminated ceramic capacitors, but also various electronic components such as ceramic multilayer substrates.

### Experimental Example 1

The present experimental example is intended to examine the effect of the co-existence of Bi₂O₃ in a ceramic layer with an Al internal electrode.

First, powders of BaCO₃, CaCO₃, TiO₂, and ZrO₂ were prepared as starting raw materials. These powders were weighed so as to satisfy the composition formulas for the main constituent as shown in Table 1, and mixed for 24 hours in water in a ball mill.

After the mixing, the blended powders were dried, and subjected to a heat treatment for synthesis, under the condition of 1000° C. for 2 hours. In this way, barium titanate-based main constituent powders were obtained.

Next, a Bi₂O₃ powder was prepared as an accessory constituent, weighed for the parts by weight of Bi₂O₃ contained with respect to 100 parts by weight of the main constituent as shown in Table 1, and added to the main constituent powders. The powders were mixed for 24 hours in water in a ball mill, and dried to provide ceramic raw material powders.

The ceramic raw material powders were, in an organic solvent including ethanol and toluene, dispersed, and mixed with the addition of a polyvinyl butyral-based organic binder, thereby providing a ceramic slurry. This ceramic slurry was subjected to sheet forming, thereby providing ceramic green sheets.

Next, on the ceramic green sheets, an internal electrode layer of the metal shown in Table 1 was formed through deposition by a sputtering method. The film thickness was approximately 2 μm. The ceramic green sheets with the internal electrode layers formed were stacked so as to alternate the sides to which the internal electrode layers were extracted, and subjected to pressure bonding to obtain a raw laminated body.

This raw laminated body was heated at 270° C. in the atmosphere to remove the binder. After this, the temperature was increased at 100° C./min, and firing was carried out at 850° C. for 1 minute in the atmosphere. An Ag paste containing an epoxy resin was applied onto both end surfaces of the laminated body obtained, and subjected to curing at 180° C. in the atmosphere to provide external electrodes connected to the internal electrodes.

The laminated ceramic capacitors obtained in the way described above were about 2.0 mm in length, about 1.0 mm in width, and about 1.0 mm in thickness, the ceramic layers were approximately 10 μm in thickness, the area of the overlap between the internal electrodes was about 1.7 μm², and the effective number of layers was 5, for example.

For the samples obtained, the electrostatic capacitance was measured with the use of an automatic bridge-type measurement instrument. The values for the electrostatic capacitance are shown in Table 1.

In addition, a voltage of 50 V was applied under the conditions of temperature: 85° C. and humidity: 85% to thirty samples for each sample number, and the numbers of samples with an insulation resistance value down to 1 MΩ or less were counted after 100 hours to regard these numbers as the numbers of defectives in a moisture resistance loading test. The numbers of defectives are also shown in Table 1.

TABLE 1

| | | | Additive | | | Number of |
|---|---|---|---|---|---|---|
| | | | Amount of | Main | | Defectives |
| | | | Accessory | Constituent | Electrostatic | in Moisture |
| Sample | Main | Accessory | Constituent | of Internal | Capacitance | Resistance |
| Number | Constituent | Constituent | (parts by weight) | Electrode | (nF) | Loading Test |
| 1 | BaTiO₃ | Bi₂O₃ | 5 | Ag | 15.7 | 15 |
| 2 | BaTiO₃ | Bi₂O₃ | 5 | Ag/Pd = 7/3 | 15.7 | 12 |
| 3 | BaTiO₃ | Bi₂O₃ | 5 | Pd | 15.9 | 6 |
| 4 | BaTiO₃ | Bi₂O₃ | 5 | Al | 9.6 | 0 |
| 5 | (Ba_{0.95}Ca_{0.05})TiO₃ | Bi₂O₃ | 5 | Al | 9.5 | 0 |
| 6 | Ba(Ti_{0.98}Zr_{0.02})O₃ | Bi₂O₃ | 5 | Al | 9.8 | 0 |
| 7 | BaTiO₃ | LiF | 5 | Al | 9.3 | 6 |
| 8 | BaTiO₃ | ZnO/CuO | 4/1 | Al | 9.2 | 8 |

There are samples 1 to 3 respectively using Ag, an Ag/Pd alloy, and Pd. While favorable electrostatic capacitance was achieved as a result, substantial numbers of defectives were produced in the moisture resistance loading test.

Samples 4 to 6 within the scope of the present invention achieved favorable moisture resistance.

There are samples 7 and 8 respectively using LiF and ZnO—CuO in place of Bi₂O₃. These samples also produced substantial numbers of defectives in the moisture resistance loading test.

Further, FIG. 2 is a photograph of a surface obtained by polishing a cross section of sample 4, in which the interface and its vicinity are magnified between a ceramic layer and an internal electrode. A layer is observed at the interface between the ceramic layer and the internal electrode. The composition analysis of the layer by WDX revealed that the layer is an oxide layer containing Al and Bi.

### Experimental Example 2

The present experimental example is intended to examine changes depending on the Bi₂O₃ amount in the ceramic layer.

First, a main constituent powder of BaTiO₃ was obtained in the same way as in Experimental Example 1.

Next, a Bi₂O₃ powder was prepared as an accessory constituent, weighed for the parts by weight of Bi₂O₃ contained with respect to 100 parts by weight of the main constituent as shown in Table 2, and added to the main constituent powders. The powders were mixed for 24 hours in water in a ball mill, and dried to provide ceramic raw material powders.

With the use of these ceramic raw material powders, samples of similar laminated ceramic capacitors were prepared through the same steps as in Experimental Example 1. It is to be noted that Al was preferably used as the metal species of internal electrodes for all of the samples.

For the samples obtained, the electrostatic capacitance and the number of defectives in a moisture resistance loading test are shown in Table 2 in the same manner as in Experimental Example 1.

TABLE 2

| | | | Additive | | | Number of |
|---|---|---|---|---|---|---|
| | | | Amount of | Main | | Defectives |
| | | | Accessory | Constituent | Electrostatic | in Moisture |
| Sample | Main | Accessory | Constituent | of Internal | Capacitance | Resistance |
| Number | Constituent | Constituent | (parts by weight) | Electrode | (nF) | Loading Test |
| 101 | BaTiO₃ | Bi₂O₃ | 0.5 | Al | 9.2 | 0 |
| 102 | BaTiO₃ | Bi₂O₃ | 1 | Al | 9.5 | 0 |
| 103 | BaTiO₃ | Bi₂O₃ | 10 | Al | 9.7 | 0 |
| 104 | BaTiO₃ | Bi₂O₃ | 20 | Al | 9.7 | 0 |
| 105 | BaTiO₃ | Bi₂O₃ | 25 | Al | 9.3 | 0 |

According to Table 2, samples 102 to 104 with the Bi₂O₃ amount of about 1 part by weight or more and about 20 parts by weight or less yielded higher results in terms of electrostatic capacitance.

### Experimental Example 3

The present experimental example is intended to verify the effect of CuO further contained in the composition constituting ceramic layers.

First, main constituent powders of the compositions shown in Table 3 were prepared in the same way as in Experimental Example 1.

Next, a Bi₂O₃ powder and a CuO powder were prepared, weighed for the parts by weight of Bi₂O₃ contained and of CuO contained with respect to 100 parts by weight of the main constituent as shown in Table 3, and added to the main constituent powders. The powders were mixed for 24 hours in water in a ball mill, and dried to provide ceramic raw material powders.

With the use of these ceramic raw material powders, samples of similar laminated ceramic capacitors were prepared through the same steps as in Experimental Example 1. It is to be noted that Al was preferably used as the metal species of internal electrodes for all of the samples. In addition, the firing temperature was varied in the range of 750° C. to 800° C. as shown in Table 3.

For the samples obtained, the electrostatic capacitance and the number of defectives in a moisture resistance loading test are shown in Table 3 in the same manner as in Experimental Example 1.

TABLE 3

| | | Bi₂O₃ | CuO | | | | Number of |
|---|---|---|---|---|---|---|---|
| | | Additive | Additive | Main | | | Defectives |
| | | Amount | Amount | Constituent | Firing | Electrostatic | in Moisture |
| Sample | Main | (parts | (parts | of Internal | Temperature | Capacitance | Resistance |
| Number | Constituent | by weight) | by weight) | Electrode | (° C.) | (nF) | Loading Test |
| 201 | BaTiO₃ | 5 | 0.01 | Al | 800 | 9.7 | 0 |
| 202 | BaTiO₃ | 5 | 0.05 | Al | 750 | 10.0 | 0 |
| 203 | BaTiO₃ | 5 | 0.1 | Al | 750 | 10.1 | 0 |
| 204 | BaTiO₃ | 5 | 0.3 | Al | 750 | 10.2 | 0 |
| 205 | BaTiO₃ | 5 | 0.5 | Al | 750 | 10.0 | 0 |
| 206 | BaTiO₃ | 5 | 1.0 | Al | 800 | 9.8 | 0 |
| 207 | (Ba_{0.98}Ca_{0.02})TiO₃ | 5 | 0.3 | Al | 750 | 10.1 | 0 |
| 208 | Ba(Ti_{0.94}Zr_{0.06})O₃ | 5 | 0.3 | Al | 750 | 10.3 | 0 |

According to Table 3, samples 201 to 208 further containing, in addition to Bi₂O₃, CuO at about 0.01 parts by weight or more and about 1 part by weight or less yielded higher results in terms of electrostatic capacitance at the lower firing temperatures, as compared with the case of adding only Bi₂O₃.

The laminated ceramic electronic component according to various preferred embodiments of the present invention is able to be applied to, in particular, laminated ceramic capacitors, ceramic multilayer substrates, etc., and intended to contribute improvements in reliability therefor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A laminated ceramic electronic component comprising:
a laminated body including a plurality of stacked ceramic layers and a plurality of internal electrodes arranged along interfaces between the ceramic layers; and
an external electrode located on an outer surface of the laminated body; wherein
the ceramic layers have a composition including a main constituent of a barium titanate-based compound and Bi₂O₃; and
the internal electrodes have a main constituent of Al.

2. The laminated ceramic electronic component according to claim 1, wherein a content of the Bi₂O₃ with respect to 100 parts by weight of the main constituent in the ceramic layers is about 1 part by weight or more and about 20 parts by weight or less.

3. The laminated ceramic electronic component according to claim 1, wherein the ceramic layers further include CuO at about 0.01 parts by weight or more and about 1 part by weight or less with respect to 100 parts by weight of the main constituent.

4. The laminated ceramic electronic component according to claim 2, wherein the ceramic layers further include CuO at about 0.01 parts by weight or more and about 1 part by weight or less with respect to 100 parts by weight of the main constituent.

5. The laminated ceramic electronic component according to claim 1, wherein an oxide layer containing Al and Bi is located at interfaces between the ceramic layers and the internal electrodes.

6. The laminated ceramic electronic component according to claim 2, wherein an oxide layer containing Al and Bi is located at interfaces between the ceramic layers and the internal electrodes.

7. The laminated ceramic electronic component according to claim 3, wherein an oxide layer containing Al and Bi is located at interfaces between the ceramic layers and the internal electrodes.

8. The laminated ceramic electronic component according to claim 4, wherein an oxide layer containing Al and Bi is located at interfaces between the ceramic layers and the internal electrodes.

9. The laminated ceramic electronic component according to claim 1, wherein the internal electrodes are made of Al only.

10. The laminated ceramic electronic component according to claim 9, wherein an amount of Al in the internal electrodes is about 90% or more in terms of molar ratio.

11. The laminated ceramic electronic component according to claim 1, wherein the internal electrodes are made of an alloy of Al.

12. The laminated ceramic electronic component according to claim 11, wherein an amount of Al in the internal electrodes is about 90% or more in terms of molar ratio.

13. The laminated ceramic electronic component according to claim 1, wherein the barium titanate-based compound is perovskite BaTiO₃.

14. The laminated ceramic electronic component according to claim 13, wherein some of Ba is substituted with Ca and/or Sr, and some of Ti is substituted with Zr and/or Hf.

15. The laminated ceramic electronic component according to claim 14, wherein a substitution amount of Ca and Sr is about 20 mol % or less and a substitution amount of Zr and Hf is about 10 mol % or less.

16. The laminated ceramic electronic component according to claim 1, wherein a molar ratio between a Ba site and a Ti site in the main constituent of the barium titanate-based compound and Bi₂O₃ is about 0.97 or more and about 1.05 or less.

17. The laminated ceramic electronic component according to claim 1, wherein the ceramic layers include at least one of Mg, Mn, V, Al, Ni, Co, and Zr.

18. The laminated ceramic electronic component according to claim 1, wherein the laminated ceramic electronic component is a laminated ceramic capacitor or a ceramic multilayer substrate.

19. A laminated ceramic capacitor comprising:
a laminated body including a plurality of stacked ceramic layers and a plurality of internal electrodes arranged along interfaces between the ceramic layers; and
an external electrode located on an outer surface of the laminated body; wherein
the ceramic layers have a composition including a main constituent of a barium titanate-based compound and Bi₂O₃; and
the internal electrodes have a main constituent of Al.

20. A ceramic multilayer substrate comprising:
a laminated body including a plurality of stacked ceramic layers and a plurality of internal electrodes arranged along interfaces between the ceramic layers; and
an external electrode located on an outer surface of the laminated body; wherein
the ceramic layers have a composition including a main constituent of a barium titanate-based compound and Bi₂O₃; and
the internal electrodes have a main constituent of Al.
